(19) United States
(12) Patent Application Publication
(10) Pub. No.: US 2026/0161551 A1
(43) Pub. Date: Jun. 11, 2026

(54) LOCALITY-AWARE GARBAGE COLLECTION PROCESSING FOR STORAGE SYSTEMS

(71) Applicant: Dell Products L.P., Round Rock, TX (US)

(72) Inventor: Yosef Shatsky, Karnei Shomron (IL)

(21) Appl. No.: 18/974,965

(22) Filed: Dec. 10, 2024

(51) Int. Cl. G06F 12/02

(52) U.S. Cl. CPC G06F 12/0253; G06F 2212/7205

(57) ABSTRACT

An apparatus comprises at least one processing device configured to determine a locality factor for each of at least a subset of data blocks stored in a storage system, the locality factor for a given data block characterizing an amount of available storage capacity in one or more other data blocks neighboring the given data block. The at least one processing device is also configured to select at least one data block in the subset for garbage collection processing based at least in part on the determined locality factors. The at least one processing device is further configured to perform garbage collection processing for the selected data block by moving one or more data items stored in the selected data block, together with one or more data items stored in at least one other one of the data blocks neighboring the selected data block, to an additional data block.

### BACKGROUND

Various types of storage systems, including storage systems implementing software-defined storage (SDS) solutions, may be configured to run workloads from multiple different end-users or applications. Different end-users or applications may have different performance and feature requirements for their associated workloads. In some workloads, performance may be most important. In other workloads, capacity utilization or other features requirements may be most important. There is thus a need for techniques which enable a storage system to offer flexibility in storage offerings for workloads with different performance and feature requirements.

### SUMMARY

Illustrative embodiments of the present disclosure provide techniques for locality-aware garbage collection processing for storage systems.

In one embodiment, an apparatus comprises at least one processing device comprising a processor coupled to a memory. The at least one processing device is configured to determine a locality factor for each of at least a subset of a plurality of data blocks stored in a storage system, the locality factor for a given one of the plurality of data blocks in the subset of the plurality of data blocks characterizing an amount of available storage capacity in one or more other ones of the plurality of data blocks neighboring the given data block. The at least one processing device is also configured to select at least one data block in the subset of the plurality of data blocks for garbage collection processing based at least in part on the determined locality factors. The at least one processing device is further configured to perform garbage collection processing for the selected at least one data block by moving one or more data items stored in the selected at least one data block, together with one or more data items stored in at least one other one of the plurality of data blocks neighboring the selected at least one data block, to an additional one of the plurality of data blocks.

These and other illustrative embodiments include, without limitation, methods, apparatus, networks, systems and processor-readable storage media.

### BRIEF DESCRIPTION OF THE DRAWINGS

FIGS. 1A and 1B schematically illustrate an information processing system comprising a storage system configured for locality-aware garbage collection processing in an illustrative embodiment.

FIG. 2 is a flow diagram of an exemplary process for locality-aware garbage collection processing in an illustrative embodiment.

FIG. 3 shows a table illustrating percentages of valid data for a set of data blocks in an illustrative embodiment.

FIG. 4 shows a volume and disk address space mapping in an illustrative embodiment.

FIG. 5 shows a table illustrating example cases of capacity factors for a set of data blocks in an illustrative embodiment.

FIG. 6 shows a table illustrating locality factors for different example cases of capacity factors for a set of data blocks in an illustrative embodiment.

FIG. 7 schematically illustrates a framework of a server node for implementing a storage node which hosts logic for locality-aware garbage collection processing in an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

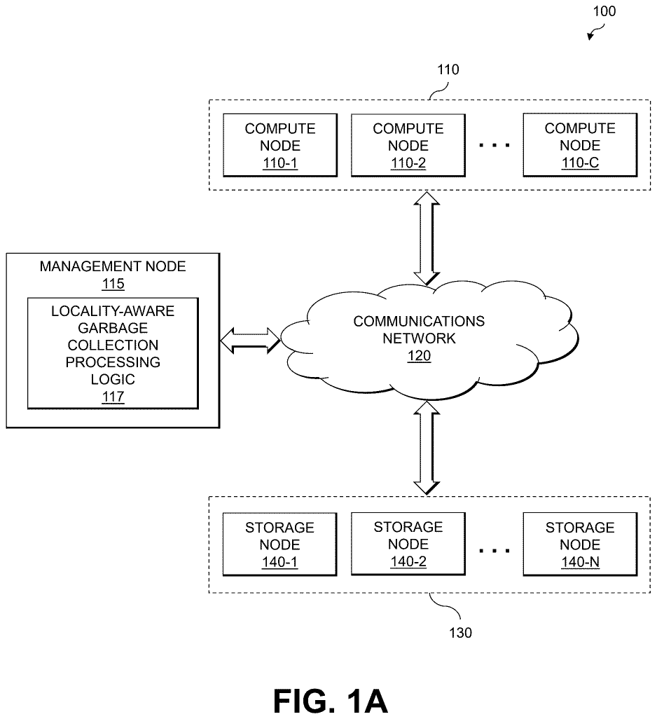

FIGS. 1A and 1B schematically illustrate an information processing system which is configured for locality-aware garbage collection processing according to an exemplary embodiment of the disclosure. More specifically, FIG. 1A schematically illustrates an information processing system 100 which comprises a plurality of compute nodes 110-1, 110-2, . . . , 110-C (collectively referred to as compute nodes 110, or each singularly referred to as a compute node 110), one or more management nodes 115 (which support a management layer of the system 100), a communications network 120, and a data storage system 130 (which supports a data storage layer of the system 100). The data storage system 130 comprises a plurality of storage nodes 140-1, 140-2, . . . , 140-N (collectively referred to as storage nodes 140, or each singularly referred to as a storage node 140). In the context of the exemplary embodiments described herein, the management nodes 115 and the data storage system 130 implement locality-aware garbage collection (GC) processing logic 117 supporting optimization or improvement of IO processing in the data storage system 130. FIG. 1B schematically illustrates an exemplary framework of at least one or more of the storage nodes 140.

In particular, as shown in FIG. 1B, the storage node 140 comprises a storage controller 142 and a plurality of storage devices 146. In general, the storage controller 142 implements data storage and management methods that are configured to divide the storage capacity of the storage devices 146 into storage pools and logical volumes. Storage controller 142 is further configured to implement locality-aware GC processing logic 117 in accordance with the disclosed embodiments, as will be described in further detail below. Various other examples are possible. It is to be noted that the storage controller 142 may include additional modules and other components typically found in conventional implementations of storage controllers and storage systems, although such additional modules and other components are omitted for clarity and simplicity of illustration.

In the embodiment of FIGS. 1A and 1B, the locality-aware GC processing logic 117 may be implemented at least in part within the one or more management nodes 115 as well as in one or more of the storage nodes 140 of the data storage system 130. This may include implementing different portions of the locality-aware GC processing logic 117 functionality described herein within the management nodes 115 and the storage nodes 140. In other embodiments, however, the locality-aware GC processing logic 117 may be implemented entirely within the management nodes 115 or entirely within the storage nodes 140. In still other embodiments, at least a portion of the functionality of the locality-aware GC processing logic 117 is implemented in one or more of the compute nodes 110.

The compute nodes 110 illustratively comprise physical compute nodes and/or virtual compute nodes which process data and execute workloads. For example, the compute nodes 110 can include one or more server nodes (e.g., bare metal server nodes) and/or one or more virtual machines. In some embodiments, the compute nodes 110 comprise a cluster of physical server nodes or other types of computers of an enterprise computer system, cloud-based computing system or other arrangement of multiple compute nodes associated with respective users. In some embodiments, the compute nodes 110 include a cluster of virtual machines that execute on one or more physical server nodes.

The compute nodes 110 are configured to process data and execute tasks/workloads and perform computational work, either individually, or in a distributed manner, to thereby provide compute services such as execution of one or more applications on behalf of each of one or more users associated with respective ones of the compute nodes. Such applications illustratively issue IO requests that are processed by a corresponding one of the storage nodes 140. The term “input-output” as used herein refers to at least one of input and output. For example, IO requests may comprise write requests and/or read requests directed to stored data of a given one of the storage nodes 140 of the data storage system 130.

The compute nodes 110 are configured to write data to and read data from the storage nodes 140 in accordance with applications executing on those compute nodes for system users. The compute nodes 110 communicate with the storage nodes 140 over the communications network 120. While the communications network 120 is generically depicted in FIG. 1A, it is to be understood that the communications network 120 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., Ethernet storage network), or various portions or combinations of these and other types of networks.

In this regard, the term “network” as used herein is therefore intended to be broadly construed so as to encompass a wide variety of different network arrangements, including combinations of multiple networks possibly of different types, which enable communication using, e.g., Transfer Control/Internet Protocol (TCP/IP) or other communication protocols such as Fibre Channel (FC), FC over Ethernet (FCOE), Internet Small Computer System Interface (iSCSI), Peripheral Component Interconnect express (PCIe), InfiniBand, Gigabit Ethernet, etc., to implement IO channels and support storage network connectivity. Numerous alternative networking arrangements are possible in a given embodiment, as will be appreciated by those skilled in the art.

The data storage system 130 may comprise any type of data storage system, or a combination of data storage systems, including, but not limited to, a storage area network (SAN) system, a network attached storage (NAS) system, a direct-attached storage (DAS) system, etc., as well as other types of data storage systems comprising software-defined storage, clustered or distributed virtual and/or physical infrastructure. The term “data storage system” as used herein should be broadly constructed and not viewed as being limited to storage systems of any particular type or types. In some embodiments, the storage nodes 140 comprise storage server nodes having one or more processing devices each having a processor and a memory, possibly implementing virtual machines and/or containers, although numerous other configurations are possible. In some embodiments, one or more of the storage nodes 140 can additionally implement functionality of a compute node, and vice-versa. The term “storage node” as used herein is therefore intended to be broadly construed, and a storage system in some embodiments can be implemented using a combination of storage nodes and compute nodes.

In some embodiments, as schematically illustrated in FIG. 1B, the storage node 140 is a physical server node or storage appliance, wherein the storage devices 146 comprise DAS resources (internal and/or external storage resources) such as hard-disk drives (HDDs), solid-state drives (SSDs), Flash memory cards, or other types of non-volatile memory (NVM) devices such non-volatile random-access memory (NVRAM), phase-change RAM (PC-RAM) and magnetic RAM (MRAM). These and various combinations of multiple different types of storage devices 146 may be implemented in the storage node 140. In this regard, the term “storage device” as used herein is intended to be broadly construed, so as to encompass, for example, SSDs, HDDs, flash drives, hybrid drives or other types of storage media. The storage devices 146 are connected to the storage node 140 through any suitable host interface, e.g., a host bus adapter, using suitable protocols such as ATA, SATA, eSATA, NVMe, NVMeOF, SCSI, SAS, etc. In other embodiments, the storage node 140 can be network connected to one or more NAS nodes over a local area network.

The storage controller 142 is configured to manage the storage devices 146 and control IO access to the storage devices 146 and/or other storage resources (e.g., DAS or NAS resources) that are directly attached or network-connected to the storage node 140. In some embodiments, the storage controller 142 is a component (e.g., storage data server) of a software-defined storage (SDS) system which supports the virtualization of the storage devices 146 by separating the control and management software from the hardware architecture. More specifically, in a software-defined storage environment, the storage controller 142 comprises an SDS storage data server that is configured to abstract storage access services from the underlying storage hardware to thereby control and manage IO requests issued by the compute nodes 110, as well as to support networking and connectivity. In this instance, the storage controller 142 comprises a software layer that is hosted by the storage node 140 and deployed in the data path between the compute nodes 110 and the storage devices 146 of the storage node 140, and is configured to respond to data IO requests from the compute nodes 110 by accessing the storage devices 146 to store/retrieve data to/from the storage devices 146 based on the IO requests.

In a software-defined storage environment, the storage controller 142 is configured to provision, orchestrate and manage the local storage resources (e.g., the storage devices 146) of the storage node 140. For example, the storage controller 142 implements methods that are configured to create and manage storage pools (e.g., virtual pools of block storage) by aggregating capacity from the storage devices 146. The storage controller 142 can divide a storage pool into one or more volumes and expose the volumes to the compute nodes 110 as virtual block devices. For example, a virtual block device can correspond to a volume of a storage pool. Each virtual block device comprises any number of actual physical storage devices, wherein each block device is preferably homogenous in terms of the type of storage devices that make up the block device (e.g., a block device only includes either HDD devices or SSD devices, etc.).

In the software-defined storage environment, each of the storage nodes 140 in FIG. 1A can run an instance of the storage controller 142 to convert the respective local storage resources (e.g., DAS storage devices and/or NAS storage devices) of the storage nodes 140 into local block storage. Each instance of the storage controller 142 contributes some or all of its local block storage (HDDs, SSDs, PCIe, NVMe and flash cards) to an aggregated pool of storage of a storage server node cluster (e.g., cluster of storage nodes 140) to implement a server-based storage area network (SAN) (e.g., virtual SAN). In this configuration, each storage node 140 is part of a loosely coupled server cluster which enables “scale-out” of the software-defined storage environment, wherein each instance of the storage controller 142 that runs on a respective one of the storage nodes 140 contributes its local storage space to an aggregated virtual pool of block storage with varying performance tiers (e.g., HDD, SSD, etc.) within a virtual SAN.

In some embodiments, in addition to the storage controllers 142 operating as SDS storage data servers to create and expose volumes of a storage layer, the software-defined storage environment comprises other components such as (i) SDS data clients that consume the storage layer and (ii) SDS metadata managers that coordinate the storage layer, which are not specifically shown in FIG. 1A. More specifically, on the client-side (e.g., compute nodes 110), an SDS data client (SDC) is a lightweight block device driver that is deployed on each server node that consumes the shared block storage volumes exposed by the storage controllers 142. In particular, the SDCs run on the same servers as the compute nodes 110 which require access to the block devices that are exposed and managed by the storage controllers 142 of the storage nodes 140. The SDC exposes block devices representing the virtual storage volumes that are currently mapped to that host. In particular, the SDC serves as a block driver for a client (server), wherein the SDC intercepts IO requests, and utilizes the intercepted IO request to access the block storage that is managed by the storage controllers 142. The SDC provides the operating system or hypervisor (which runs the SDC) access to the logical block devices (e.g., volumes).

The SDCs have knowledge of which SDS control systems (e.g., storage controller 142) hold its block data, so multipathing can be accomplished natively through the SDCs. In particular, each SDC knows how to direct an IO request to the relevant destination SDS storage data server (e.g., storage controller 142). In this regard, there is no central point of routing, and each SDC performs its own routing independent from any other SDC. This implementation prevents unnecessary network traffic and redundant SDS resource usage. Each SDC maintains peer-to-peer connections to every storage controller 142 that manages the storage pool. A given SDC can communicate over multiple pathways to all of the storage nodes 140 which store data that is associated with a given IO request. This multi-point peer-to-peer fashion allows the SDS to read and write data to and from all points simultaneously, eliminating bottlenecks and quickly routing around failed paths.

The management nodes 115 in FIG. 1A implement a management layer that is configured to manage and configure the storage environment of the system 100. In some embodiments, the management nodes 115 comprise the SDS metadata manager components, wherein the management nodes 115 comprise a tightly-coupled cluster of nodes that are configured to supervise the operations of the storage cluster and manage storage cluster configurations. The SDS metadata managers operate outside of the data path and provide the relevant information to the SDS clients and storage servers to allow such components to control data path operations. The SDS metadata managers are configured to manage the mapping of SDC data clients to the SDS data storage servers. The SDS metadata managers manage various types of metadata that are required for system operation of the SDS environment such as configuration changes, managing the SDS data clients and data servers, device mapping, values, snapshots, system capacity including device allocations and/or release of capacity, RAID protection, recovery from errors and failures, and system rebuild tasks including rebalancing.

While FIG. 1A shows an exemplary embodiment of a two-layer deployment in which the compute nodes 110 are separate from the storage nodes 140 and connected by the communications network 120, in other embodiments, a converged infrastructure (e.g., hyperconverged infrastructure) can be implemented to consolidate the compute nodes 110, storage nodes 140, and communications network 120 together in an engineered system. For example, in a hyperconverged deployment, a single-layer deployment is implemented in which the storage data clients and storage data servers run on the same nodes (e.g., each node deploys a storage data client and storage data servers) such that each node is a data storage consumer and a data storage supplier. In other embodiments, the system of FIG. 1A can be implemented with a combination of a single-layer and two-layer deployment.

Regardless of the specific implementation of the storage environment, as noted above, various modules of the storage controller 142 of FIG. 1B collectively provide data storage and management methods that are configured to perform various functions as follows. In particular, a storage virtualization and management services module may implement any suitable logical volume management (LVM) system which is configured to create and manage local storage volumes by aggregating the local storage devices 146 into one or more virtual storage pools that are thin-provisioned for maximum capacity, and logically dividing each storage pool into one or more storage volumes that are exposed as block devices (e.g., raw logical unit numbers (LUNs)) to the compute nodes 110 to store data. In some embodiments, the storage devices 146 are configured as block storage devices where raw volumes of storage are created and each block can be controlled as, e.g., an individual disk drive by the storage controller 142. Each block can be individually formatted with a same or different file system as required for the given data storage system application.

In some embodiments, the storage pools are primarily utilized to group storage devices based on device types and performance. For example, SSDs are grouped into SSD pools, and HDDs are grouped into HDD pools. Furthermore, in some embodiments, the storage virtualization and management services module implements methods to support various data storage management services such as data protection, data migration, data deduplication, replication, thin provisioning, snapshots, data backups, etc.

Storage systems, such as the data storage system 130 of system 100, may be required to provide both high performance and a rich set of advanced data service features for end-users thereof (e.g., users operating compute nodes 110, applications running on compute nodes 110). Performance may refer to latency, or other metrics such as IO operations per second (IOPS), bandwidth, etc. Advanced data service features may refer to data service features of storage systems including, but not limited to, services for data resiliency, thin provisioning, data reduction, space efficient snapshots, etc. Fulfilling both performance and advanced data service feature requirements can represent a significant design challenge for storage systems. This may be due to different advanced data service features consuming significant resources and processing time. Such challenges may be even greater in software-defined storage systems in which custom hardware is not available for boosting performance.

Device tiering may be used in some storage systems, such as in storage systems that contain some relatively “fast” and expensive storage devices and some relatively “slow” and less expensive storage devices. In device tiering, the “fast” devices may be used when performance is the primary requirement, where the “slow” and less expensive devices may be used when capacity is the primary requirement. Such device tiering may also use cloud storage as the “slow” device tier. Some storage systems may also or alternately separate devices offering the same performance level to gain performance isolation between different sets of storage volumes. For example, the storage systems may separate the “fast” devices into different groups to gain performance isolation between storage volumes on such different groups of the “fast” devices.

Illustrative embodiments provide functionality for optimizing or improving performance of GC processing. The locality-aware GC processing logic 117 is configured to perform GC processing for the data storage system which takes into account “locality” of data blocks. For example, locality factors may be calculated for data blocks in the data storage system 130, where the locality factors characterize, for each data block, an amount of available storage capacity (e.g., empty space or invalidated data) in “neighboring” data blocks. The neighboring data blocks may be determined using a logical locality (e.g., based on which data blocks store data items preceding and subsequent to data items in a given data block in a logical address space), physical locality (e.g., data blocks which precede and are subsequent to a given data block) and possibly other metrics indicative of relationships between data blocks. The locality factors are used to select an order for performing GC processing (e.g., which data blocks to perform GC processing on first or before others).

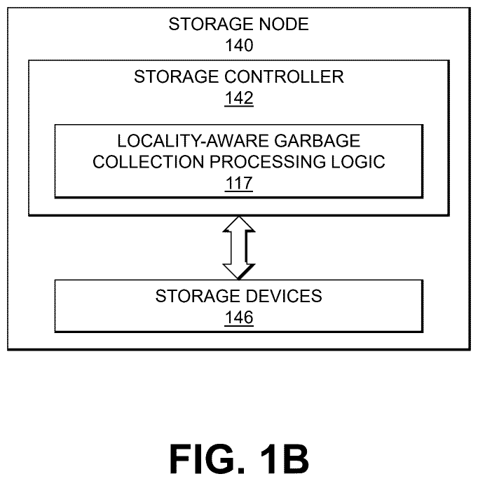

An exemplary process for locality-aware garbage collection processing will now be described in more detail with reference to the flow diagram of FIG. 2. It is to be understood that this particular process is only an example, and that additional or alternative processes for locality-aware garbage collection processing may be used in other embodiments.

In this embodiment, the process includes steps 200 through 204. These steps are assumed to be performed using the locality-aware GC processing logic 117, which as noted above may be implemented in the management nodes 115 of system 100, in storage nodes 140 of the data storage system 130 of system 100, in compute nodes 110 of system 100, combinations thereof, etc. The process begins with step 200, determining a locality factor for each of at least a subset of a plurality of data blocks stored in a storage system (e.g., the data storage system 130). The locality factor for a given one of the plurality of data blocks in the subset of the plurality of data blocks characterizes an amount of available storage capacity in one or more other ones of the plurality of data blocks neighboring the given data block.

The locality factor for the given data block may be determined based at least in part on calculating ratios of the amount of available storage capacity in the one or more other ones of the plurality of data blocks neighboring the given data block to an amount of available storage capacity in the given data block. The locality factor for the given data block may be determined based at least in part on averaging the calculated ratios for a designated number of neighboring data blocks. If the calculated ratio for one of the one or more other ones of the plurality of data blocks neighboring the given data block exceeds a designated threshold, the value of the calculated ratio for said one of the one or more other ones of the plurality of data blocks may be set to zero.

The one or more other ones of the plurality of data blocks neighboring the given data block may be determined utilizing a logical locality in a logical address space of the storage system. The one or more other ones of the plurality of data blocks neighboring the given data block may comprise: at least one data block storing one or more data items which precede one or more data items stored in the given data block in the logical address space of the storage system; and at least one data block storing one or more data items which succeed the one or more data items stored in the given data block in the logical address space of the storage system. The one or more other ones of the plurality of data blocks neighboring the given data block may alternatively comprise: at least two data blocks storing one or more data items which precede one or more data items stored in the given data block in the logical address space of the storage system; and at least two data blocks storing one or more data items which succeed the one or more data items stored in the given data block in the logical address space of the storage system.

The one or more other ones of the plurality of data blocks neighboring the given data block may be determined utilizing a physical locality in a physical address space of the storage system. The one or more other ones of the plurality of data blocks neighboring the given data block may comprise: at least one data block preceding the given data block in the physical address space of the storage system; and at least one data block succeeding the given data block in the physical address space of the storage system. The one or more other ones of the plurality of data blocks neighboring the given data block may alternatively comprise: at least two data blocks preceding the given data block in the physical address space of the storage system; and at least two data blocks succeeding the given data block in the physical address space of the storage system.

In step 202, at least one data block in the subset of the plurality of data blocks is selected for garbage collection processing based at least in part on the determined locality factors. Selecting the at least one data block for garbage collection processing may be further based at least in part on an amount of available storage capacity in each data block in the subset of the plurality of data blocks. Selecting the at least one data block for garbage collection may be based at least in part on determining, for each data block in the subset of the plurality of data blocks, a weighted sum of (i) a capacity factor characterizing the amount of available storage capacity in that data block and (ii) the locality factor characterizing the amount of available storage capacity in the one or more other ones of the plurality of data blocks neighboring that given data block. A first weight for the capacity factor may be greater than a second weight for the locality factor.

In step 204, garbage collection processing is performed for the selected at least one data block by moving one or more data items stored in the selected at least one data block, together with one or more data items stored in at least one other one of the plurality of data blocks neighboring the selected at least one data block, to an additional one of the plurality of data blocks. The storage system may utilize a log structured array architecture for storing data.

Storage systems may store data using a log structured array (LSA) architecture, where new data is written to new locations instead of updating data at its existing location. The new data is placed into data blocks which are written in full. In a storage system implementing an LSA architecture, existing data becomes invalidated over time (e.g., as the existing data is updated by new data writes), which creates “holes” of unused space in data blocks. Because the LSA architecture writes full data blocks (e.g., new data writes are cached until enough new data is written to fill a new data block), the holes in data blocks are not written to until an entire data block is freed. To achieve this, a process referred to as garbage collection (GC) is used to move remaining valid data out of partially invalidated data blocks to a new data block, thereby freeing up the partially invalidated data blocks.

GC processing will combine data from multiple partially invalidated data blocks into a single new data block. For example, 4 data blocks that each have 25% valid data remaining can be combined into a single data block. It should be noted that the “source” data blocks do not necessarily contain related data, and may belong to different data sources (e.g., files, volumes, database tables, etc.). This leads to fragmentation of the source data. Fragmentation reduces performance, because the storage system must access more data blocks and more metadata (MD). The MD may not be in memory (e.g., random-access memory or RAM), requiring swapping in from storage drives.

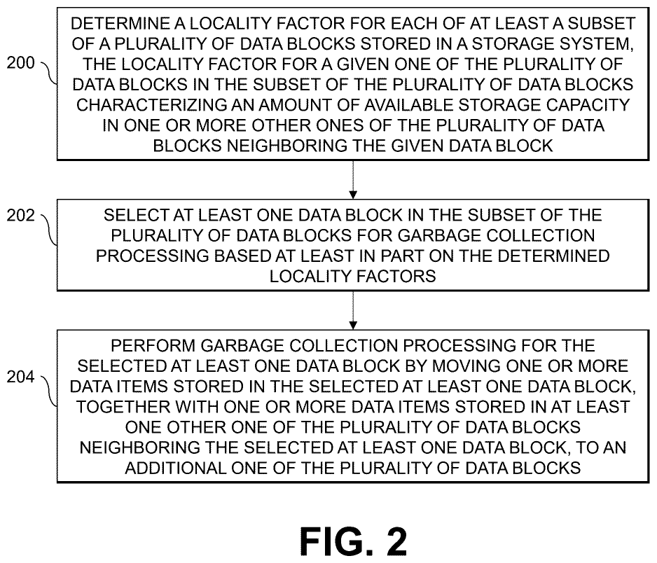

Conventional approaches for GC processing choose which data blocks to perform GC on based on how much valid data remains in the data blocks. Data blocks with less valid data are garbage collected (GCed) before data blocks with more remaining valid data. This is useful, because garbage collecting (GCing) data blocks with less valid data can free up more data blocks at a reduced effort (e.g., a smaller amount of data to be moved), and thus may be viewed as “cheaper” from a resource consumption perspective. Cheaper GC processing allows for better performance and faster space reclamation. The outcome of such conventional GC processing, however, is that unrelated data blocks may be GCed together. FIG. 3 shows a table 300 illustrating a set of six data blocks and their associated percentages of valid data. Conventional GC processing will simply select the data blocks which have the least amount of valid data to be GCed together (up to the capacity limit of a data block). Thus, for the data blocks shown in the table 300, the GC order will be: 3, 1, 6, 4, 2, 5. Data blocks 1, 3 and 6 will be written together, breaking the natural order of the data. To account for this, defragmentation (defrag) processing may be performed to realign the data to match the order of the MD. As GC processing runs, it creates fragmentation. Defrag processing may be run (e.g., occasionally, periodically, etc.) to fix the fragmentation caused by the GC processing and regain performance.

Illustrative embodiments provide technical solutions which take into account or consider fragmentation implications as part of the GC processing itself, through performing locality-aware GC processing. It should be noted that the locality-aware GC processing does not necessarily replace the need for defrag processing altogether, but it does allow defrag processing to be run less often, or to make it work less hard when it does run. The locality-aware GC processing defines a locality factor, and weights the locality factor together with a capacity factor (e.g., charactering the amount of valid data in a data block). Through taking into account the locality factor, the locality-aware GC processing will try to combine blocks with neighboring content, at some sacrifice of GCing blocks with more data that are less optimal from a capacity perspective.

For each data block, a capacity factor and a locality factor are defined. In some embodiments, the capacity factor and the locality factor are each a number in the range [0,1], where 1 indicates a good candidate for locality-aware GC and 0 indicates a bad candidate for locality-aware GC. The capacity factor is defined by the amount of invalidated data in the block (e.g., invalidated data divided by the block size). The locality factor is more complicated, as it considers neighboring data blocks (e.g., a set of sequential data blocks in an LSA architecture).

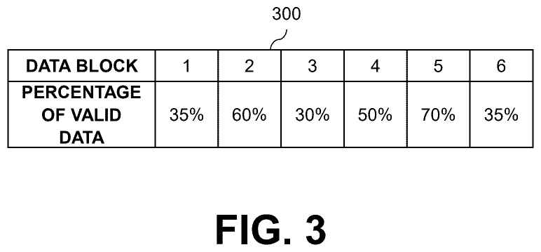

FIG. 4 shows a volume or logical address space 401 and a disk or physical address space 403. Data items 410-1 through 410-8 (collectively, data items 410) are stored in the volume address space 401, which are mapped to data blocks 430-1 through 430-5 (collectively, data block 430 also denoted as DB1 through DB5). The data items 410-1 and 410-2 are stored in data block 430-1 (DB1), the data items 410-4 and 410-5 are stored in data block 430-2 (DB2), the data item 410-3 is stored in data block 430-3 (DB3), the data items 410-6 and 410-7 are stored in data block 430-4 (DB4), and the data item 410-8 is stored in the data block 430-5 (DB5). Here, it is assumed that each of the data items 410 has an equal size, and that each of the data blocks 430 has the capacity to store three data items. Thus, data block 430-1 (DB1) has one empty or invalidated space 411, the data block 430-3 (DB2) has one empty or invalidated space 411, the data block 430-3 (DB3) has two empty or invalidated spaces 411, the data block 430-4 (DB4) has one empty or invalidated space 411, and the data block 430-5 (DB5) has two empty or invalidated spaces 411.

Assume, for example, that the first data block selected for GC is data block 430-3 (DB3), since it is the emptiest (tied with data block 430-5). For logical locality: the preceding neighbor data block for data block 430-3 (DB3) is data block 430-1 (DB1) since it contains data items 410-2 and 410-2 that come before data item 410-3 in the logical address space; and the succeeding neighbor data block for data block 430-3 (DB3) is data block 430-2 (DB2) since it contains data items 410-4 and 410-5 that come after the data item 410-3 in the logical address space. For physical locality: the preceding neighbor data block for data block 430-3 (DB3) is data block 430-2 (DB2) since it is the physical data block that precedes data block 430-3 (DB3) in the physical address space; and the succeeding neighbor data block for data block 430-3 (DB3) is data block 430-4 (DB4) since it is the physical data block that succeeds data block 430-3 (DB3) in the physical address space. It should be noted that GC is performed on full data blocks, though the definition of “neighboring” data blocks may change based on whether logical or physical locality is used. Logical locality may be more beneficial, but the required metadata for determining logical locality may not always be available and thus physical locality may alternatively be used.

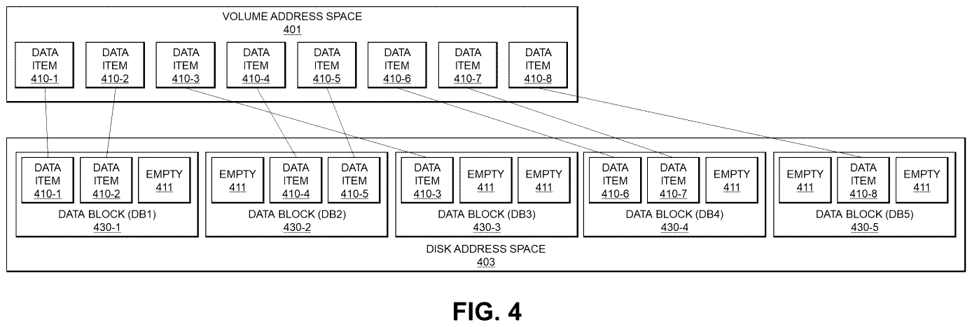

FIG. 5 shows a table 500 illustrating various cases or scenarios for a set of five data blocks, with the third (Data Block 3) being the data block that is currently being evaluated for locality-aware GC processing. The second and fourth data blocks (Data Block 2 and Data Block 4) are the immediate or first-degree neighbors of Data Block 3, and the first and fifth data blocks (Data Block 1 and Data Block 5) are the second-degree neighbors of Data Block 3. While in this example first and second-degree neighbors are considered, it should be appreciated that locality-aware GC processing may be expanded to use any desired number of neighbors (e.g., third-degree neighbors, fourth-degree neighbors, etc.). It is also permissible to consider only first-degree neighbors, rather than first and second-degree neighbors. The values in the table 500 are the capacity factors (e.g., how “empty” each data block is), with the capacity factors being used to calculate the locality factor for each case and eventually the final ranking of Data Block 3 in each case.

Locality-aware GC processing advantageously is able to distinguish between cases 1 and 2 in the table 500. Focusing on Data Block 3, in Case 1 the Data Block 3 will be GCed alone, because all its neighbors are full (e.g., 0% capacity factors). In Case 2, all the neighbors of the Data Block 3 are highly invalidated (e.g., 70% capacity factors) and thus are very good candidates to be GCed together. In some embodiments, the locality factor for a data block may be defined based on the capacity factors of its neighbors. This, however, does not capture the advantage of having a single neighbor that is very empty (e.g., Case 3 in the table 500), compared to multiple neighbors that are only slightly empty (e.g., Case 4 in the table 500). Thus, some embodiments utilize a more advanced locality factor determination which properly gives Case 3 in the table 500 a higher ranking than Case 4.

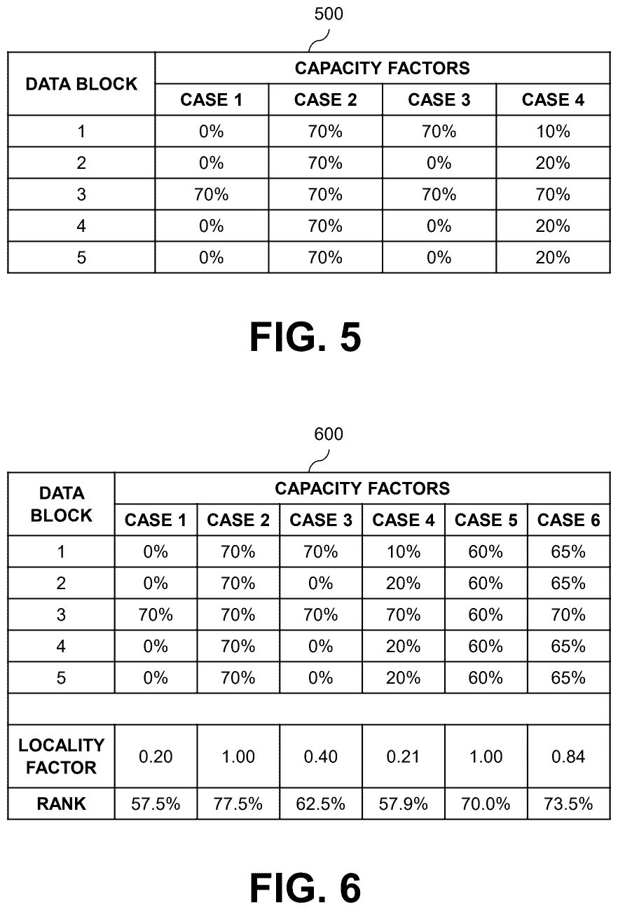

In the description below, CFᵢi denotes the capacity factor for data block i, which is calculated as the invalidated percentage of the data block i. LFᵢ denotes the locality factor for data block i, which may be computed according to:

$${LF}_{i} = {\sum }_{j = - 2}^{2} \frac{{( {CF}_{j} / {CF}_{i} )}^{3}}{5}$$

where 5 is a parameter and represents the number of neighbor data blocks being considered. The formula for computing the locality factor includes the term (CFⱼ/CFᵢ)₃, which gives a “grade” to each neighbor data block. The data block being evaluated (Data Block 3 in table 500 and table 600 of FIG. 6 described below) is selected because it is the emptiest and therefore it will have the highest capacity factor value among its neighbors. CFⱼ/CFᵢ gives a ratio between the capacity factor of each neighbor data block, depicted by CFⱼ, and the capacity factor of the original data block, CFᵢ. The power of 3 gives the grade an exponential impact, to strongly reduce the rank as the difference in capacity grows. Next, the average of the core formula per neighbor is taken. Since we have 5 items, the formula is a sum from

$$j - 2 … j + 2 ( {\sum }_{j = - 2}^{2} ( … ) / 5 ) .$$

K denotes the weight to give the locality factor, and in some embodiments is set to 25%. It should be noted that the value of K is an implementation choice that is configurable. Rank; is the rank for data block i, and is computed according to:

$${Rank}_{i} = K * {LF}_{i} + ( 1 - K ) * {CF}_{i}$$

The formula for computing the rank gives a standard weighting between the locality factor and the capacity factor. The proposed value of 25% for K means that the locality factor gets a weighting of 25% and the capacity factor gets a weighting of 75%. This provides a final ranking that is also in the range of 0 to 1.

FIG. 6 shows a table 600 illustrating capacity factors, locality factors and ranks computed for a set of five data blocks (Data Blocks 1 through 5) in six different cases (Cases 1 through 6). The third data block (Data Block 3) is the data block being evaluated for GC, which has first-degree neighbors (Data Blocks 2 and 4) and second-degree neighbors (Data Blocks 1 and 5). The rank ordering of the cases is as follows:
1. Case 2: has the highest rank because it is best both from capacity and locality aspects;
2. Case 6: has the best capacity and good locality;
3. Case 5: has good locality, though it is not the best remaining case from the capacity perspective;
4. Case 3: has the next best locality due to its highly ranked neighbor (Data Block 1);
5. Case 4: has a negligible advantage over Case 1 because it has some free space in the neighbor data blocks;
6. Case 1: has no neighbor data blocks with available capacity.

In some embodiments, the locality factor may be “zeroed out” if the difference in capacity between a data block and one or more of its neighbor data blocks is too large. Thus, the locality formula may be augmented with the following condition:

$$If ( \frac{{CF}_{j}}{{CF}_{i}} < 75 \% ) set result to 0$$

where 75% is a configurable threshold for the difference in capacity between neighboring data blocks which results in zeroing out the locality factor.

In conventional approaches for GC processing, the capacity of data blocks is only updated if there is a change to a particular data block itself. In the locality-aware GC processing described herein, changes in the capacity of data blocks can also lead to changes in the locality factors for their neighboring data blocks. Thus, if there is a change to the capacity factor for data block i, CFᵢ, then the locality factors of the data block i and its neighboring data blocks should be updated. This results in a tradeoff when determining or selecting the number of neighboring data blocks to consider when computing the locality factors. Continuing with the example above where a data block set of five data blocks is considered, each change to the capacity of a data block would result in updating the locality factors for five data blocks.

The technical solutions described herein provide functionality for having GC processing factor in locality (e.g., implementing locality-aware GC processing). The technical solutions described herein also have the ability to balance between locality and capacity in locality-aware GC processing (e.g., through selection of the value of K described above). The technical solutions further provide formula for evaluating the locality potential of the neighborhood of a data block.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

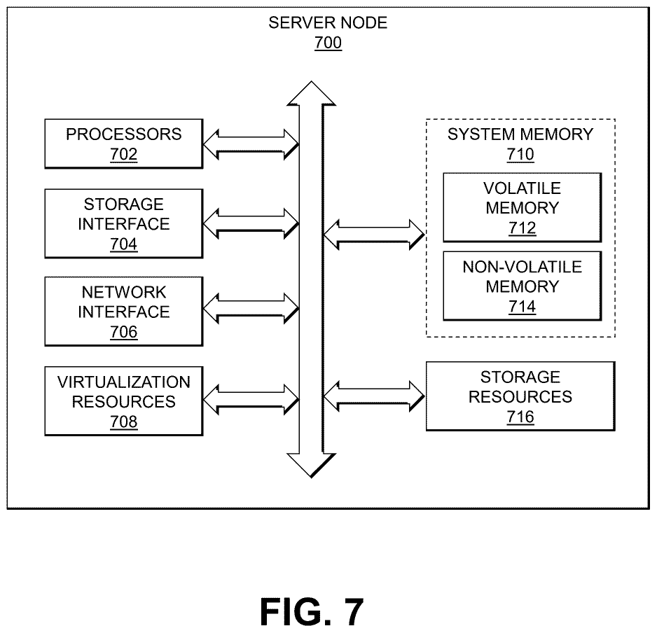

FIG. 7 schematically illustrates a framework of a server node (or more generally, a computing node) for hosting logic for locality-aware garbage collection processing according to an exemplary embodiment of the disclosure. The server node 700 comprises processors 702, storage interface circuitry 704, network interface circuitry 706, virtualization resources 708, system memory 710, and storage resources 716. The system memory 710 comprises volatile memory 712 and non-volatile memory 714. The processors 702 comprise one or more types of hardware processors that are configured to process program instructions and data to execute a native operating system (OS) and applications that run on the server node 700.

For example, the processors 702 may comprise one or more CPUs, microprocessors, microcontrollers, application specific integrated circuits (ASICs), field programmable gate arrays (FPGAs), and other types of processors, as well as portions or combinations of such processors. The term “processor” as used herein is intended to be broadly construed so as to include any type of processor that performs processing functions based on software, hardware, firmware, etc. For example, a “processor” is broadly construed so as to encompass all types of hardware processors including, for example, (i) general purpose processors which comprise “performance cores” (e.g., low latency cores), and (ii) workload-optimized processors, which comprise any possible combination of multiple “throughput cores” and/or multiple hardware-based accelerators. Examples of workload-optimized processors include, for example, graphics processing units (GPUs), digital signal processors (DSPs), system-on-chip (SoC), tensor processing units (TPUs), image processing units (IPUs), deep learning accelerators (DLAs), artificial intelligence (AI) accelerators, and other types of specialized processors or coprocessors that are configured to execute one or more fixed functions.

The storage interface circuitry 704 enables the processors 702 to interface and communicate with the system memory 710, the storage resources 716, and other local storage and off-infrastructure storage media, using one or more standard communication and/or storage control protocols to read data from or write data to volatile and non-volatile memory/storage devices. Such protocols include, but are not limited to, non-volatile memory express (NVMe), peripheral component interconnect express (PCIe), Parallel ATA (PATA), Serial ATA (SATA), Serial Attached SCSI (SAS), Fibre Channel, etc. The network interface circuitry 706 enables the server node 700 to interface and communicate with a network and other system components. The network interface circuitry 706 comprises network controllers such as network cards and resources (e.g., network interface controllers (NICs) (e.g., SmartNICs, RDMA-enabled NICs), Host Bus Adapter (HBA) cards, Host Channel Adapter (HCA) cards, I/O adaptors, converged Ethernet adaptors, etc.) to support communication protocols and interfaces including, but not limited to, PCIe, DMA and RDMA data transfer protocols, etc.

The virtualization resources 708 can be instantiated to execute one or more services or functions which are hosted by the server node 700. For example, the virtualization resources 708 can be configured to implement the various modules and functionalities as discussed herein. In one embodiment, the virtualization resources 708 comprise virtual machines that are implemented using a hypervisor platform which executes on the server node 700, wherein one or more virtual machines can be instantiated to execute functions of the server node 700. As is known in the art, virtual machines are logical processing elements that may be instantiated on one or more physical processing elements (e.g., servers, computers, or other processing devices). That is, a “virtual machine” generally refers to a software implementation of a machine (i.e., a computer) that executes programs in a manner similar to that of a physical machine. Thus, different virtual machines can run different operating systems and multiple applications on the same physical computer.

A hypervisor is an example of what is more generally referred to as “virtualization infrastructure.” The hypervisor runs on physical infrastructure, e.g., CPUs and/or storage devices, of the server node 700, and emulates the CPUs, memory, hard disk, network and other hardware resources of the host system, enabling multiple virtual machines to share the resources. The hypervisor can emulate multiple virtual hardware platforms that are isolated from each other, allowing virtual machines to run, e.g., Linux and Windows Server operating systems on the same underlying physical host. The underlying physical infrastructure may comprise one or more commercially available distributed processing platforms which are suitable for the target application.

In another embodiment, the virtualization resources 708 comprise containers such as Docker containers or other types of Linux containers (LXCs). As is known in the art, in a container-based application framework, each application container comprises a separate application and associated dependencies and other components to provide a complete filesystem, but shares the kernel functions of a host operating system with the other application containers. Each application container executes as an isolated process in user space of a host operating system. In particular, a container system utilizes an underlying operating system that provides the basic services to all containerized applications using virtual-memory support for isolation. One or more containers can be instantiated to execute one or more applications or functions of the server node 700 as well execute one or more of the various modules and functionalities as discussed herein. In yet another embodiment, containers may be used in combination with other virtualization infrastructure such as virtual machines implemented using a hypervisor, wherein Docker containers or other types of LXCs are configured to run on virtual machines in a multi-tenant environment.

The various components of, e.g., the locality-aware GC processing logic 117, comprise program code that is loaded into the system memory 710 (e.g., volatile memory 712), and executed by the processors 702 to perform respective functions as described herein. In this regard, the system memory 710, the storage resources 716, and other memory or storage resources as described herein, which have program code and data tangibly embodied thereon, are examples of what is more generally referred to herein as “processor-readable storage media” that store executable program code of one or more software programs. Articles of manufacture comprising such processor-readable storage media are considered embodiments of the disclosure. An article of manufacture may comprise, for example, a storage device such as a storage disk, a storage array or an integrated circuit containing memory. The term “article of manufacture” as used herein should be understood to exclude transitory, propagating signals.

The system memory 710 comprises various types of memory such as volatile RAM, NVRAM, or other types of memory, in any combination. The volatile memory 712 may be a dynamic random-access memory (DRAM) (e.g., DRAM DIMM (Dual In-line Memory Module), or other forms of volatile RAM. The non-volatile memory 714 may comprise one or more of NAND Flash storage devices, SSD devices, or other types of next generation non-volatile memory (NGNVM) devices. The system memory 710 can be implemented using a hierarchical memory tier structure wherein the volatile memory 712 is configured as the highest-level memory tier, and the non-volatile memory 714 (and other additional non-volatile memory devices which comprise storage-class memory) is configured as a lower level memory tier which is utilized as a high-speed load/store non-volatile memory device on a processor memory bus (i.e., data is accessed with loads and stores, instead of with I/O reads and writes). The term “memory” or “system memory” as used herein refers to volatile and/or non-volatile memory which is utilized to store application program instructions that are read and processed by the processors 702 to execute a native operating system and one or more applications or processes hosted by the server node 700, and to temporarily store data that is utilized and/or generated by the native OS and application programs and processes running on the server node 700. The storage resources 716 can include one or more HDDs, SSD storage devices, etc.

It is to be understood that the above-described embodiments of the disclosure are presented for purposes of illustration only. Many variations may be made in the particular arrangements shown. For example, although described in the context of particular system and device configurations, the techniques are applicable to a wide variety of other types of information processing systems, computing systems, data storage systems, processing devices and distributed virtual infrastructure arrangements. In addition, any simplifying assumptions made above in the course of describing the illustrative embodiments should also be viewed as exemplary rather than as requirements or limitations of such embodiments. Numerous other alternative embodiments within the scope of the appended claims will be readily apparent to those skilled in the art.

1. An apparatus comprising:
at least one processing device comprising a processor coupled to a memory;
the at least one processing device being configured:
to determine a locality factor for each of at least a subset of a plurality of data blocks stored in a storage system, the locality factor for a given one of the plurality of data blocks in the subset of the plurality of data blocks characterizing an amount of available storage capacity in one more other ones of the plurality of data blocks neighboring the given data block, wherein the locality factor for the given data block is determined based at least in part on differences between (i) a percentage of invalidated storage capacity of the given data block and (ii) percentages of invalidated storage capacity of each of at least a subset of the one or more other ones of the plurality of data blocks neighboring the given data block;
to select at least one data block in the subset of the plurality of data blocks for garbage collection processing based at least in part on the determined locality factors; and
to perform garbage collection processing for the selected at least one data block by moving one or more data items stored in the selected at least one data block, together with one or more data items stored in at least one other one of the plurality of data blocks neighboring the selected at least one data block, to an additional one of the plurality of data blocks.

2. The apparatus of claim 1 wherein the storage system utilizes a log structure array for storing data.

3. The apparatus of claim 1 wherein selecting the at least one data block for garbage collection processing is further based at least in part on an amount of available storage capacity in each data block in the subset of the plurality of data blocks.

4. The apparatus of claim 3 wherein selecting the at least one data block for garbage collection is based at least in part on determining, for each data block in the subset of the plurality of data blocks, a weighted sum of (i) a capacity factor characterizing the amount of available storage capacity in that data block and (ii) the locality factor determined for that data block.

5. The apparatus of claim 4 wherein a first weight for the capacity factor is greater than a second weight for the locality factor.

6. The apparatus of claim 1 wherein the locality factor for the given data block is determined based at least in part on calculating ratios of the amount of available storage capacity in the one or more other ones of the plurality of data blocks neighboring the given data block to an amount of available storage capacity in the given data block.

7. The apparatus of claim 6 wherein the locality factor for the given data block is determined based at least in part on averaging the calculated ratios for a designated number of neighboring data blocks.

8. The apparatus of claim 6 wherein, if the calculated ratio for one of the one or more other ones of the plurality of data blocks neighboring the given data block exceeds a designated threshold, setting the value of the calculated ratio for said one of the one or more other ones of the plurality of data blocks to zero.

9. The apparatus of claim 1 wherein the one or more other ones of the plurality of data blocks neighboring the given data block are determined utilizing a logical locality in a logical address space of the storage system.

10. The apparatus of claim 9 wherein the one or more other ones of the plurality of data blocks neighboring the given data block comprise:
at least one data block storing one or more data items which precede one or more data items stored in the given data block in the logical address space of the storage system; and
at least one data block storing one or more data items which succeed the one or more data items stored in the given data block in the logical address space of the storage system.

11. The apparatus of claim 9 wherein the one or more other ones of the plurality of data blocks neighboring the given data block comprise:
at least two data blocks storing one or more data items which precede one or more data items stored in the given data block in the logical address space of the storage system; and
at least two data blocks storing one or more data items which succeed the one or more data items stored in the given data block in the logical address space of the storage system.

12. The apparatus of claim 1 wherein the one or more other ones of the plurality of data blocks neighboring the given data block are determined utilizing a physical locality in a physical address space of the storage system.

13. The apparatus of claim 12 wherein the one or more other ones of the plurality of data blocks neighboring the given data block comprise:
at least one data block preceding the given data block in the physical address space of the storage system; and
at least one data block succeeding the given data block in the physical address space of the storage system.

14. The apparatus of claim 12 wherein the one or more other ones of the plurality of data blocks neighboring the given data block comprise:
at least two data blocks preceding the given data block in the physical address space of the storage system; and
at least two data blocks succeeding the given data block in the physical address space of the storage system.

15. A computer program product comprising a non-transitory processor-readable storage medium having stored therein program code of one or more software programs, wherein the program code when executed by at least one processing device causes the at least one processing device:
to determine a locality factor for each of at least a subset of a plurality of data blocks stored in a storage system, the locality factor for a given one of the plurality of data blocks in the subset of the plurality of data blocks characterizing an amount of available storage capacity in one or more other ones of the plurality of data blocks neighboring the given data block, wherein the locality factor for the given data block is determined based at least in part on differences between (i) a percentage of invalidated storage capacity of the given data block and (ii) percentages of invalidated storage capacity of each of at least a subset of the one or more other ones of the plurality of data blocks neighboring the given data block;
to select at least one data block in the subset of the plurality of data blocks for garbage collection processing based at least in part on the determined locality factors; and
to perform garbage collection processing for the selected at least one data block by moving one or more data items stored in the selected at least one data block, together with one or more data items stored in at least one other one of the plurality of data blocks neighboring the selected at least one data block, to an additional one of the plurality of data blocks.

16. The computer program product of claim 15 wherein selecting the at least one data block for garbage collection processing is further based at least in part on an amount of available storage capacity in each data block in the subset of the plurality of data blocks.

17. The computer program product of claim 15 wherein the locality factor for the given data block is determined based at least in part on calculating ratios of the amount of available storage capacity in the one or more other ones of the plurality of data blocks neighboring the given data block to an amount of available storage capacity in the given data block.

18. A method comprising:
determining a locality factor for each of at least a subset of a plurality of data blocks stored in a storage system, the locality factor for a given one of the plurality of data blocks in the subset of the plurality of data blocks characterizing an amount of available storage capacity in one or more other ones of the plurality of data blocks neighboring the given data block, wherein the locality factor for the given data block is determined based at least in part on differences between (i) a percentage of invalidated storage capacity of the given data block and (ii) percentages of invalidated storage capacity of each of at least a subset of the one or more other ones of the plurality of data blocks neighboring the given data block;
selecting at least one data block in the subset of the plurality of data blocks for garbage collection processing based at least in part on the determined locality factors; and
performing garbage collection processing for the selected at least one data block by moving one or more data items stored in the selected at least one data block, together with one or more data items stored in at least one other one of the plurality of data blocks neighboring the selected at least one data block, to an additional one of the plurality of data blocks;
wherein the method is performed by at least one processing device comprising a processor coupled to a memory.

19. The method of claim 18 wherein selecting the at least one data block for garbage collection processing is further based at least in part on an amount of available storage capacity in each data block in the subset of the plurality of data blocks.

20. The method of claim 18 wherein the locality factor for the given data block is determined based at least in part on calculating ratios of the amount of available storage capacity in the one or more other ones of the plurality of data blocks neighboring the given data block to an amount of available storage capacity in the given data block.
